(19) United States
(12) Patent Application Publication
(10) Pub. No.: US 2014/0196105 A1
(43) Pub. Date: Jul. 10, 2014

(54) CLOUD SYSTEM WITH ATTACK PROTECTION MECHANISM AND PROTECTION METHOD USING FOR THE SAME

(71) Applicant: DELTA ELECTRONICS, INC., Taoyuan County (TW)

(72) Inventor: Jui-Tsung HUNG, Taoyuan County (TW)

(73) Assignee: DELTA ELECTRONICS, INC., Taoyuan County (TW)

(21) Appl. No.: 14/094,826

(22) Filed: Dec. 3, 2013

(30) Foreign Application Priority Data
Jan. 9, 2013 (TW) 102100661

(51) Int. Cl. H04L 29/06

(52) U.S. Cl. CPC H04L 63/20; H04L 63/1416
USPC 726/1

(57) ABSTRACT

A cloud system includes a security center server, a monitoring server, and a host. The host is deployed by the monitoring server after booting to install a detecting procedure and execute a local security policy therein. The host provides a self-monitoring operation through the detecting procedure and replies to the monitoring server when any monitoring data therein exceeds a threshold value according to the local security policy. The monitoring server judges whether the host is attacked or not, and notifies the security center server when the host is judged to be attacked. After receiving the notification, the security center server analyzes attack types, and generates a new security policy according to analyzed results. Finally, the security center server redeploys the host by the new generated security policy, so as to update the local security policy in the host, and protects the host from the attack.

### BACKGROUND

1. Technical Field

The present disclosure relates generally to a cloud system, and more particularly to a cloud system with an attack protection mechanism and a protection method using for the same.

2. Description of Related Art

After discovering the cloud system which is attacked by external hackers or internal Trojan horse, the administrators directly judge by themselves or indirectly use algorithms to analyze so as to obtain information of attack types, sources, and purposes.

In addition, a solution for eliminating the attack needs to be submitted besides the obtained information so that the administrators can login the attacked host and manually modify the settings of the host according to the solution, thus eliminating the attack.

Furthermore, some cloud systems further provide a packet filter server. Before entering the cloud system, the packets of data and/or instructions need to be filtered by the packet filter server. After the packet filter server confirms that the filtered data and/or instructions are correct, the data and/or instructions can be sent to the corresponding hosts in the cloud system. However, the communication between the hosts and external equipment would be disconnected if the packet filter server is damaged so that all hosts are unable to access data and/or instructions.

In addition, the network traffic of the cloud system would be concentrated in the packet filter server because all packets of data and/or instructions need to be first filtered so as to cause heavy burden in operation of the cloud system.

### SUMMARY

An object of the present disclosure is to provide a cloud system with attack protection mechanism and a protection method using for the same to generate a new security policy when the host is attacked, and to redeploy the attacked host so as to easily eliminate the attack.

In order to achieve the above-mentioned object, the cloud system includes a security center server, a monitoring server, and a host. After the host boots, the host is deployed by the monitoring server to install a detecting procedure and a local security policy. The host provides a self-monitoring operation through the detecting procedure and replies to the monitoring server when any one of the monitoring data therein exceeds a threshold value according to the local security policy. The monitoring server judges whether the host is attacked or not, and notifies the security center server when the host is really attacked. After receiving the notification, the security center server analyzes attack types, and generates an updated security policy according to analyzed results. Finally, the security center server redeploys the host according to the updated security policy, so as to update the local security policy in the host, and protects the host from the attack.

Accordingly, the present disclosure has following features and advantages. When the host detects out the attack during the self-monitoring operation, the monitoring server notifies the security center server to analyze the attack type and generate an updated security policy so that the host is redeployed according to the updated security policy. Because the updated security policy is generated due to the attack occurrence, the attack can be easily eliminated after the security center server redeploys the attacked host so as to enhance protection ability of the cloud system.

### BRIEF DESCRIPTION OF DRAWINGS

The features of the present disclosure believed to be novel are set forth with particularity in the appended claims. The present disclosure itself, however, may be best understood by reference to the following detailed description of the present disclosure, which describes an exemplary embodiment of the present disclosure, taken in conjunction with the accompanying drawings, in which:

FIG. 1 is a system structure view of a cloud system with an attack protection mechanism according to a preferred embodiment of the present disclosure;

FIG. 2 is a schematic view of a cabinet in a cloud-based data center according to a preferred embodiment of the present disclosure;

FIG. 3 is a system block diagram of the cloud system with the attack protection mechanism according to a preferred embodiment of the present disclosure;

FIG. 4 is a flowchart of host deployment according to a preferred embodiment of the present disclosure;

FIG. 5 is a flowchart of security policy update according to a preferred embodiment of the present disclosure;

FIG. 6 is a flowchart of attack notification according to a preferred embodiment of the present disclosure;

FIG. 7 is a flowchart of attack protection according to a preferred embodiment of the present disclosure;

FIG. 8 is a system block diagram of the cloud system with the attack protection mechanism according to another preferred embodiment of the present disclosure; and

FIG. 9 is a flowchart of attack protection according to a preferred embodiment of the present disclosure.

### DETAILED DESCRIPTION

Reference will now be made to the drawing figures to describe the present disclosure in detail.

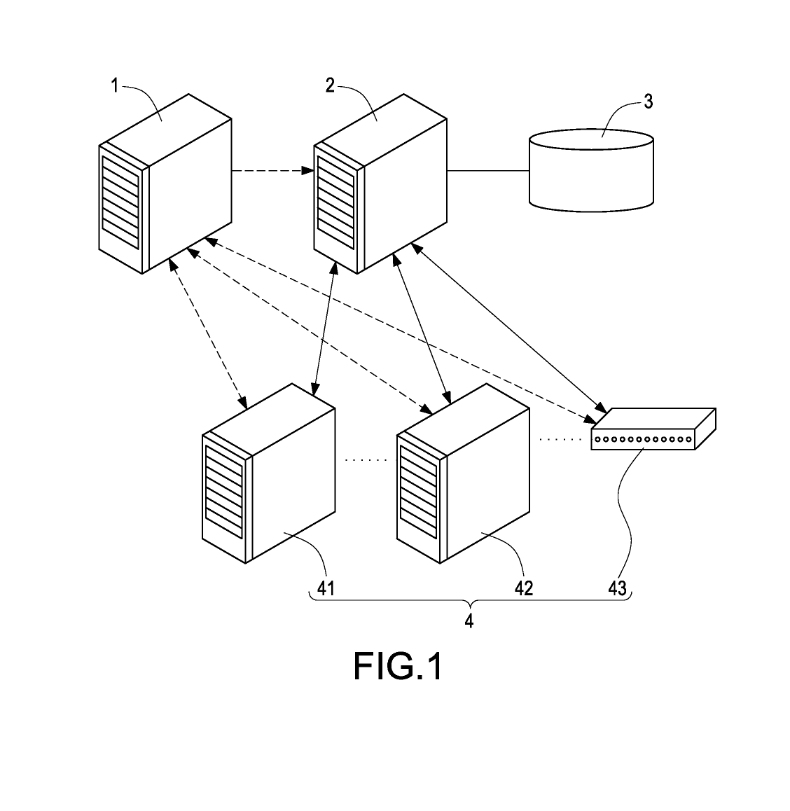

Reference is made to FIG. 1 which is a system structure view of a cloud system with an attack protection mechanism according to a preferred embodiment of the present disclosure. The cloud system mainly includes a monitoring server 1, a security center server 2, a knowledge base 3, and at least one host 4. In this embodiment, the host 4 can be various types of physical machines (PMs), such as a computing host 41, a storage host 42, or a network switch 43, or can be various types of virtual machines (VMs), such as a virtual host or a virtual switch. However, the embodiments are only exemplified but are not intended to limit the scope of the disclosure. For convenience, it is assumed that the amount of the host 4 is one but that is exemplified for further demonstration.

For the cloud system, the host 4 mainly plays a corresponding role to provide services to clients. The monitoring server 1 is connected to the host 4 to monitor and detect operation conditions of the host 4. When the host 4 is abnormal, the abnormal condition is replied to the monitoring server 1 so that the monitoring server 1 judges whether the abnormal condition of the host 4 is caused due to the attack occurrence.

In this embodiment, the “attacked host” means that the host 4 encounters a virus or hacker attack so that the throughput of the host 4 is suddenly increased or the file access rate of the host 4 is abnormal due to the injection of Trojan horse in internal files. Once the attacked situation is replied to the monitoring server 1, the monitoring server 1 can confirm that the host 4 is really attacked.

After confirming that the host 4 is attacked, the monitoring server 1 notifies the security center server 2 with events according to the monitored information so that the security center server 2 is provided to perform assessments and analyses of the events. The security center server 2 is the core of the information security in the whole cloud system. When the security center server 2 receives the event notice from the monitoring server 1, the security center server 2 assesses and analyzes the corresponding data by algorithms so as to identify the attacked type. Accordingly, the security center server 2 can provide solutions according to analyzed results to redeploy the attacked host 4 to generate a new information security policy so that the host 4 cannot be attacked by the same attack type which had occurred.

Especially, the analyzed results and solutions provided from the security center server 2 are stored in the knowledge base 3. Accordingly, any one new booting host in the cloud system is deployed through the latest information security policy so that the new host cannot be attacked by the same attack type which had occurred.

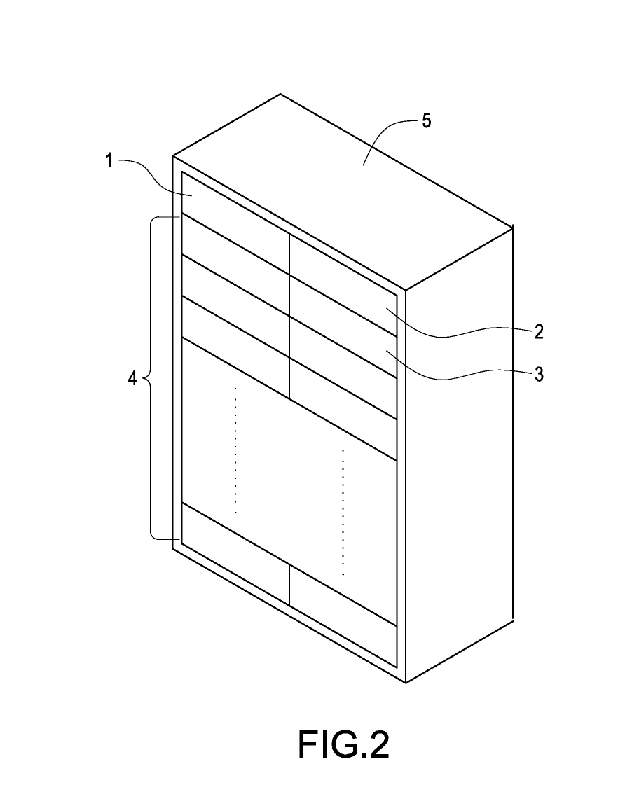

Reference is made to FIG. 2 which is a schematic view of a cabinet in a cloud-based data center according to the preferred embodiment of the present disclosure. In this embodiment, the monitoring server 1, the security center server 2, the knowledge base 3, and the host 4 can be installed in an identical cabinet 5 of a cloud-based data center, and which are physically connected to each other by a network switch (not shown) in the cabinet 5. In this embodiment, only one cabinet 5 in the cloud-based data center is exemplified. However, the embodiment is only exemplified but is not intended to limit the scope of the disclosure. In other embodiments, the monitoring server 1, the security center server 2, the knowledge base 3, and the host 4 can be installed in different cabinets of a cloud-based data center, and which are physically connected to each other.

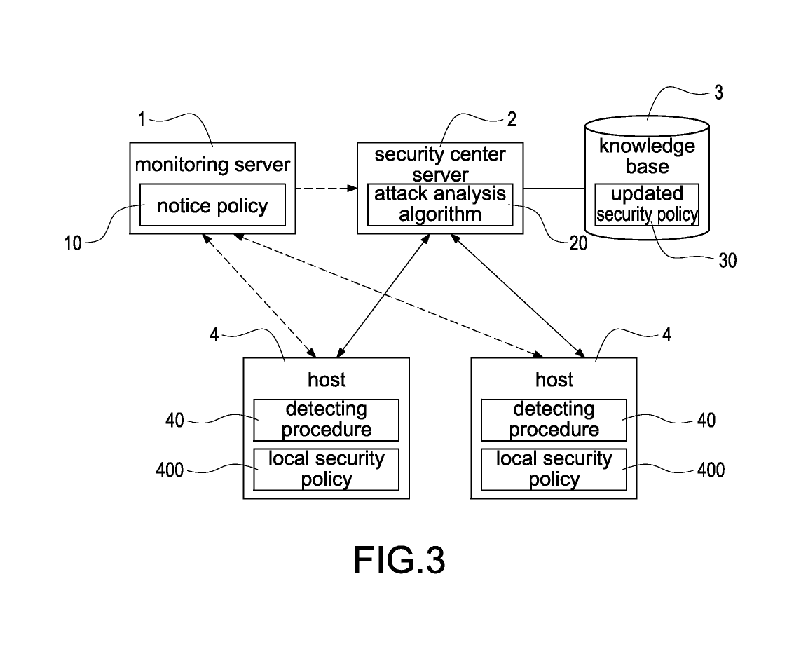

Reference is made to FIG. 3 which is a system block diagram of the cloud system with the attack protection mechanism according to the preferred embodiment of the present disclosure. After booting, the host 4 accepts deployment of the monitoring server 1 so that a detecting procedure 40 and a local security policy 400 are installed in the host 4. The host 4 executes the local security policy 400 to provide security protection, and the corresponding threshold values of the data are set. Especially, the local security policy 400 can be a firewall policy, but not limited, to prevent various possible malicious attacks.

The host 4 further provides a self-monitoring operation through the detecting procedure 40 to detect various data thereof, such as the throughput, CPU usage rate, hard disk rotation speed, hard disk capacity, temperature, humidity, procedure or file access rate, and so on. When the detecting procedure 40 detects that any one of the data exceeds the corresponding threshold value, an event will be triggered by the host 4 and that is replied to the monitoring server 1.

More specifically, the detecting procedure 40 is deployed by the monitoring server 1 and installed in the host 4 so that the host 4 replies the event to the monitoring server 1 through the detecting procedure 40. Also, the host 4 generates an event-related datum, namely, the related data of exceeding the corresponding threshold values, and simultaneously replies the event-related datum to the monitoring server 1.

When the event is triggered, the monitoring server 1 can judge whether the host 4 is unstable because of malicious attacks or other problems. More specifically, the monitoring server 1 can execute a notice policy 10 therein and analyze the event-related datum through the notice policy 10, thus judging whether the host 4 is attacked or not.

If the event is caused by other factors, the monitoring server 1 will carry out the corresponding actions, whereas the monitoring server 1 generates a warning message according to the event-related datum so that the monitoring server 1 can notify the security center server 2 with events if the host 4 is really attacked. More specifically, the monitoring server 1 judges whether the event-related datum meets the notice standard set by the notice policy 10 after analyzing the event-related datum. If “Yes”, the monitoring server 1 sends the warning message to notify the security center server 2. In which, the warning message includes the event-related datum.

When the security center server 2 receives the warning message sent from the monitoring server 1, the security center server 2 assesses the event and to analyze the attack type. Afterward, the security center server 2 generates an updated security policy 30 stored in the knowledge base 3 according to analyzed results. More specifically, the security center server 2 can execute an attack analysis algorithm 20 therein and analyze the event-related datum through the attack analysis algorithm 20 to identify the attack type and provide solutions to generate the updated security policy 30.

Finally, the security center server 2 redeploys the attacked host 4 according to the updated security policy 30 so as to update the local security policy 400 inside the host 4 to a new one. Accordingly, the technical feature of the present disclosure is that the updated security policy 30 is generated after the host 4 is attacked. Also, the updated security policy 30 is deployed by the host 4 to easily eliminate the attack. Especially, the updated security policy 30 can be a firewall policy, but not limited, to prevent various possible malicious attacks.

For example, if the attack is an external attack, the security center server 2 can calculate the source address of the external attack according to the event-related datum so as to block accessing the source address according to the updated security policy 30. For another example, if the attack is an internal attack, the security center server 2 can calculate which procedure or file launches the internal attack according to the event-related datum so as to isolate the procedure or the file, thus preventing other procedures or files of the host 4 being interfered with the internal attack. Until the host 4 is idle, the isolated procedure or the file will be deleted. However, the above-mentioned description is only a preferred embodiment but not intended to limit the scope of the disclosure. The security center server 2 can generate different updated security policies 30 depending on analyzed attack types.

Besides the attacked host 4, the security center server 2 can redeploy all hosts in the cloud system according to the updated security policy 30 so that other non-attacked hosts cannot be attacked by the same attack type which had occurred.

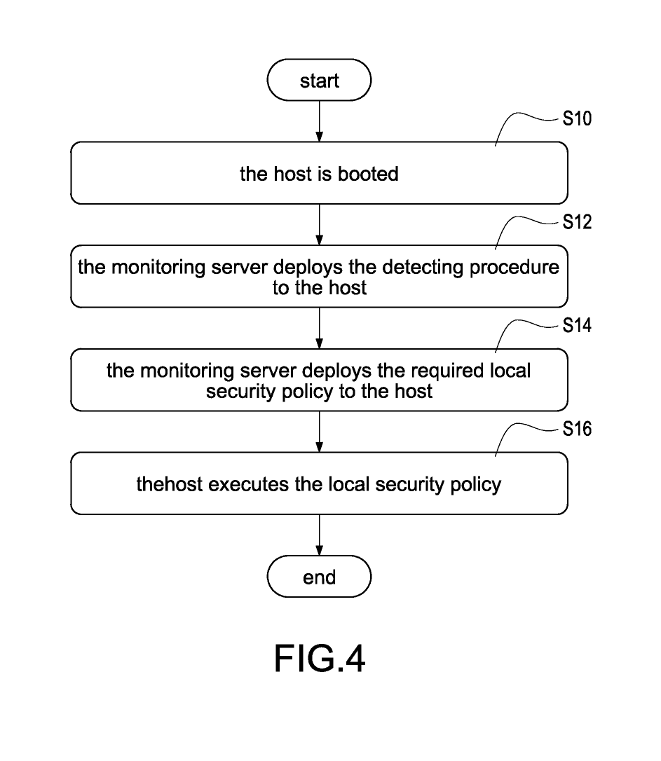

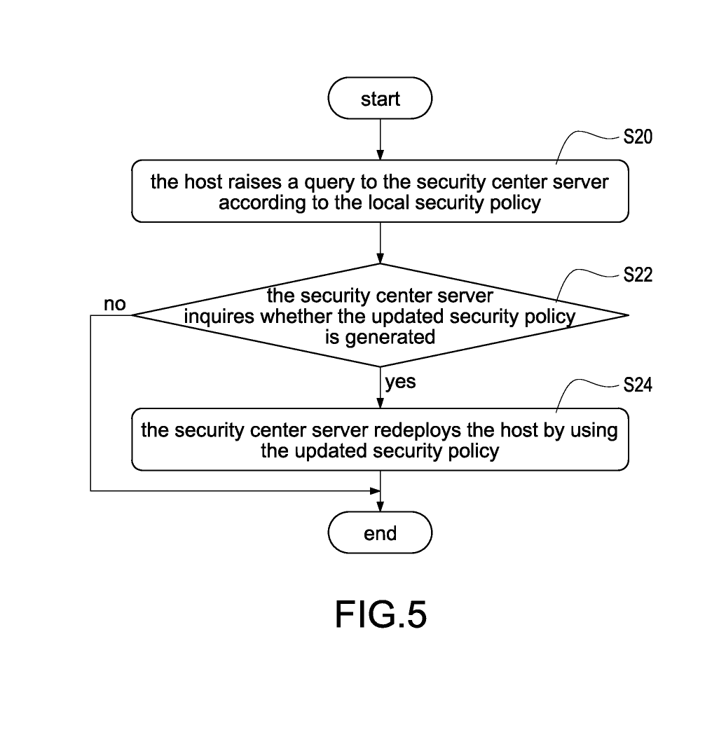

Reference is made to FIG. 4 and FIG. 5 which are flowcharts of host deployment and security policy update according to a preferred embodiment of the present disclosure, respectively. As shown in FIG. 4, the host 4 is first booted by the administrator (S10). More specifically, if the host 4 is a physical machine, the administrator can boot the host 4 by Wake on LAN technology or directly pressing the physical power button (not shown). On the contrary, the administrator can generate the host 4 by a standard generation of virtual machine if the host 4 is a virtual machine.

Afterward, the monitoring server 1 can detect out existence of the host 4 and deploy the detecting procedure 40 to the host 4 (S12) so that the host 4 provides a self-monitoring operation to detect various data thereof through the detecting procedure 40. In addition, the monitoring server 1 can also deploy the required local security policy 400 to the host 4 (S14) so that the host 4 can execute the local security policy 400 to perform the security protection (S16) and set threshold values of various data according to the local security policy 400. After the step S16, the host 4 formally became the corresponding role in the cloud system.

As shown in FIG. 5, the host 4 can further raise a query to the security center server 2 according to the local security policy 400 (S20) after the local security policy 400 is deployed to the host 4. Also, the security center server 2 inquires whether the updated security policy 30 is generated (S22). More specifically, the host 4 can raise a query to the security center server 2 by MD5 or Hash table to confirm the version of the local security policy 400 and an old/new version relationship between the local security policy 400 and the security policy of knowledge base 3.

If the updated security policy 30 has not yet generated after the security center server 2 inquires, that presents the version of the local security policy 400 is the latest so that the host 4 and the security center server 2 have nothing to do. On the contrary, if the knowledge base 3 has the updated security policy 30 after the security center server 2 inquires, the security center server 2 will redeploy the host 4 to update the version of the local security policy 400 by using the updated security policy 30 (S24) so that the host 4 can operate in the optimal protection condition.

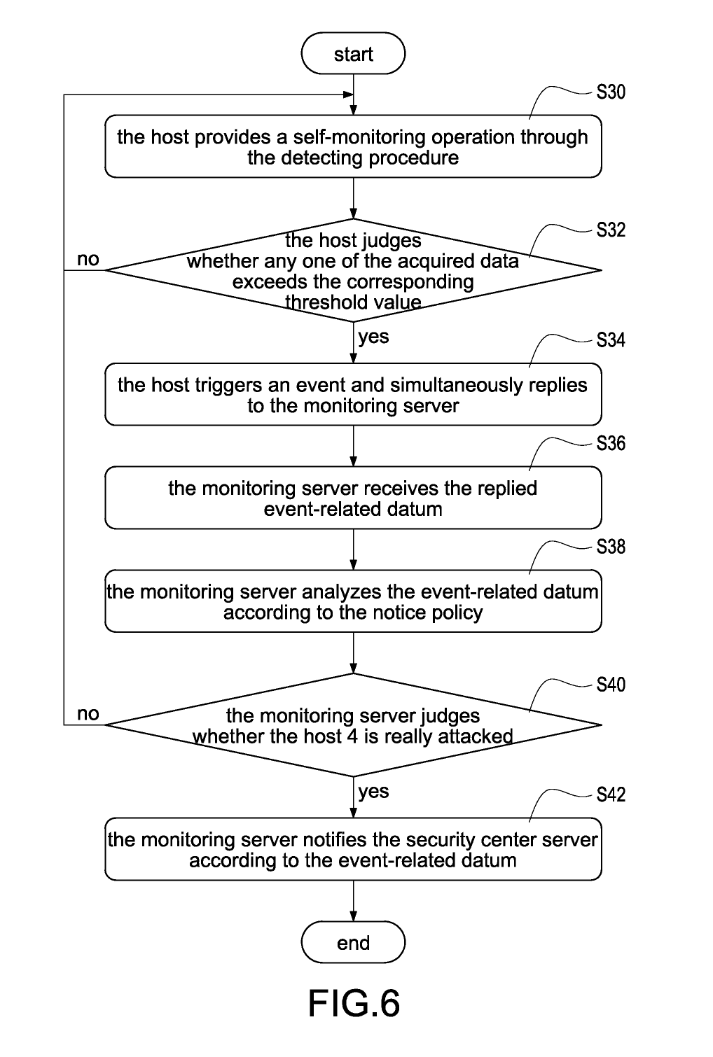

Reference is made to FIG. 6 which is a flowchart of attack notification according to a preferred embodiment of the present disclosure. First, the host 4 provides a self-monitoring operation through the detecting procedure 40 (S30) so as to acquire various data thereof, such as the throughput, CPU usage rate, hard disk rotation speed, hard disk capacity, temperature, humidity, procedure or file access rate, and so on. Afterward, the host 4 regularly judges whether any one of the acquired data exceeds the corresponding threshold value (S32). If all acquired data are correct (within the threshold values), the host 4 has nothing to do besides continually providing the self-monitoring operation.

On the contrary, if any one of the acquired data exceeds the corresponding threshold value, the host 4 triggers an event and simultaneously replies to the monitoring server 1 (S34). More specifically, the host 4 can trigger the event and simultaneously reply the event-related datum, namely, the related data of exceeding the corresponding threshold values to the monitoring server 1 so that the monitoring server 1 can perform the detailed analysis.

After the event is triggered, the monitoring server 1 is mainly used to receive the replied event-related datum from the host 4 (S36) and analyze the event-related datum according to the notice policy 10 (S38) so as to judge whether the host 4 is really attacked or not (S40). After analyzing, if the event-related datum does not meet the notice standard set by the notice policy 10, it indicates that the host 4 does not been attacked rather affected by other factors. In this condition, the monitoring server 1 will carry out the corresponding actions, such as recording data or notifying the administrator instead of notifying the security center server 2.

On the contrary, the monitoring server 1 sends the warning message to notify the security center server 2 when the host 4 is really attacked after analyzing (S42). More specifically, the monitoring server 1 notifies the security center server 2 according to the warning message generated from the event-related datum so that the security center server 2 can analyze the attack type in detail through the event-related datum.

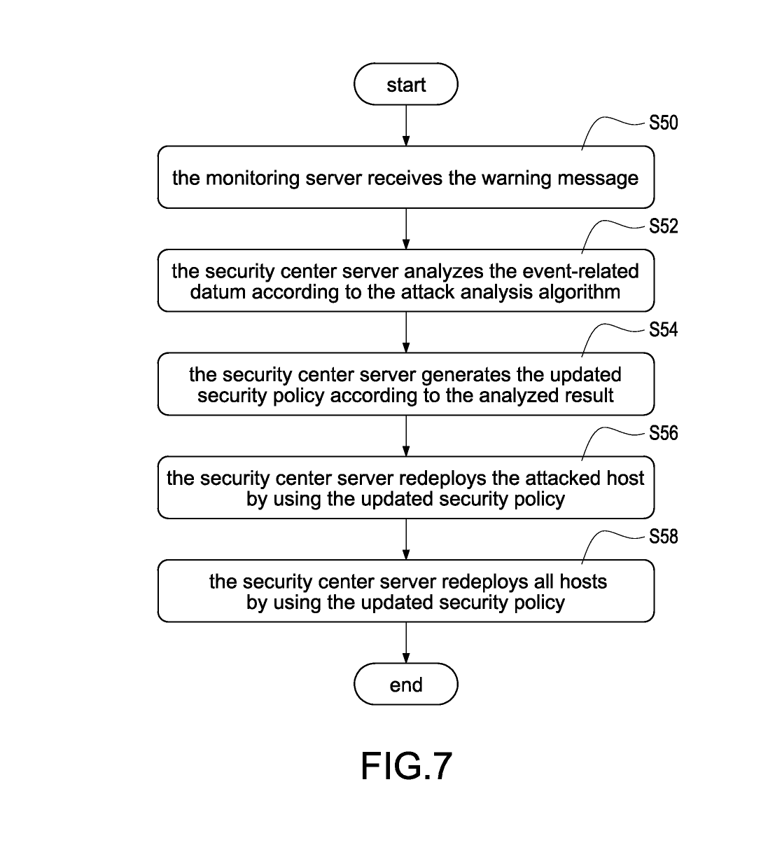

Reference is made to FIG. 7 which is a flowchart of attack protection according to a preferred embodiment of the present disclosure. Once the host 4 is probably attacked, the host 4 replies to the monitoring server 1. When the monitoring server 1 confirms that the host 4 is really attacked, the monitoring server 1 notifies the security center server 2 to receive the warning message sent from the monitoring server 1 (S50) and analyzes the attack type. More specifically, the security center server 2 analyzes the event-related datum according to the attack analysis algorithm 20 (S52) to identify the attack type and generates the updated security policy 30 according to the analyzed result (S54). That is, the updated security policy 30 is obtained by updating the original security policy according to the analyzed results so as to effectively prevent the attack.

After the step S54, the security center server 2 redeploys the attacked host 4 by using the updated security policy 30 (S56). As described above, because the updated security policy 30 is generated due to the attack occurrence, the attack can be easily eliminated after the security center server 2 redeploys the attacked host 4 so that operation of the host 4 and the various data thereof return to normal. Especially, the security center server 2 can further redeploy non-attacked hosts by using the updated security policy 30 besides the attacked host 4 (S58), that is, all hosts in the cloud system can be redeployed. Because the updated security policy 30 enhances protection ability, the non-attacked hosts cannot be attacked by the host which had been attacked when all hosts are redeployed by the updated security policy 30 so as to effectively prevent the attack.

The cloud system and protection method are provided to redeploy all hosts in the cloud system once any one of the hosts is attacked. In which, the monitoring server 1 notifies the security center server 2 to analyze the attack type and generate the updated security policy 30 according to the analyzed result. As long as all hosts in the cloud system are redeployed and the updated security policy 30 are performed, the non-attacked hosts cannot be attacked by the host which had been attacked, that is all hosts cannot be attacked by the same attack type.

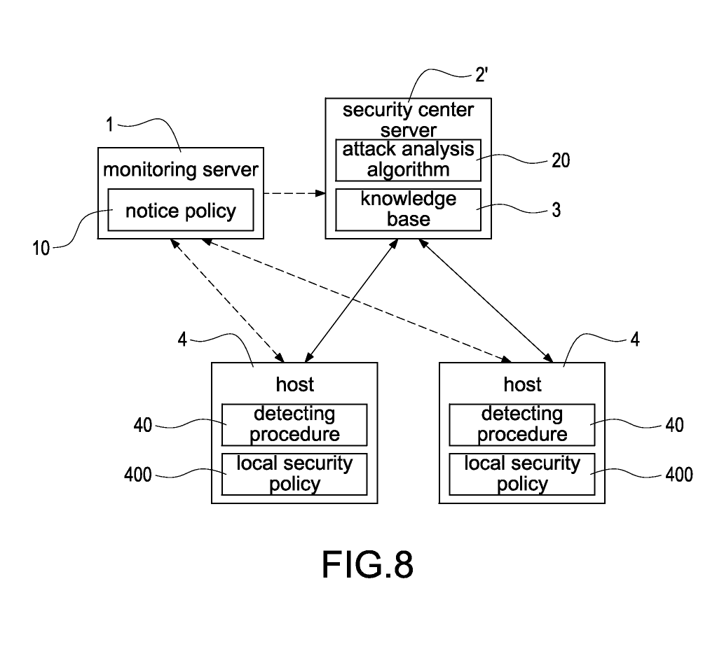

Reference is made to FIG. 8 which is a system block diagram of the cloud system with the attack protection mechanism according to another preferred embodiment of the present disclosure. In the above-mentioned example, the knowledge base 3 is a stand-alone server in the cloud system for demonstration. The knowledge base 3 plays a role of storing the updated security policy 30, which is connected to the security center server 2 through the wired connection or wireless connection. In addition, the cloud system can further provide another security center server 2′. The security center server 2′ has a storage unit and the security center server 2′ is served as the knowledge base 3 in the cloud system. In this embodiment, the cloud system does not install external physical servers to as the knowledge base 3 so as to effectively save the quantity of the servers. However, the above-mentioned description is only another preferred embodiment but not intended to limit the scope of the disclosure. The knowledge base 3 can be used alone or in combination with the security center server 2′ depending on the actual requirements of the cloud system.

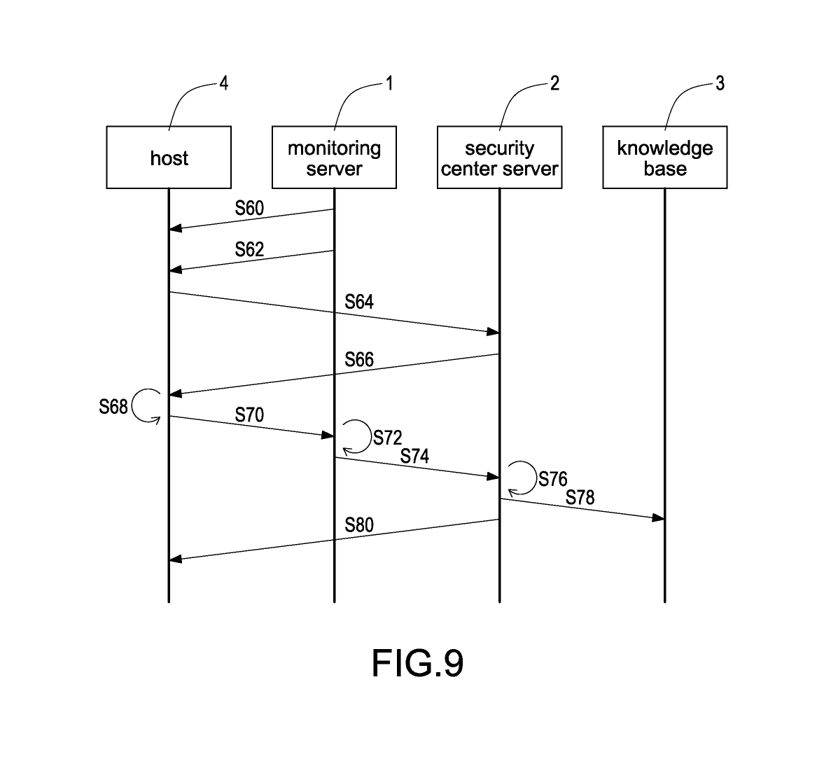

Reference is made to FIG. 9 which is a flowchart of attack protection according to a preferred embodiment of the present disclosure. First, the monitoring server 1 deploys the detecting procedure 40 for the host 4 (S60). Afterward, the monitoring server 1 deploys the local security policy 400 for the host 4 (S62). Afterward, the host 4 raises a query to the security center server 2 whether the version of the local security policy 400 is the latest (S64). Afterward, if “Yes”, the security center server 2 replies that the version of the local security policy 400 is the latest to the host 4. If “No”, namely, the updated security policy 30 is generated in the knowledge base 3, the security center server 2 deploys the host 4 to upgrade the local security policy 400 to the updated security policy 30 (S66).

After booting, the host 4 provides a self-monitoring operation to detect various data thereof through the detecting procedure 40 (S68). Also, once any one of the data exceeds the corresponding threshold value set by the local security policy 400, the host 4 triggers an event and simultaneously replies to the monitoring server 1 (S70). After receiving the reply from the host 4, the monitoring server 1 analyzes the event to judge whether the host 4 is attacked or not (S72). Afterward, if the host 4 is really attacked, the monitoring server 1 sends the warning message to notify the security center server 2.

After receiving the warning message, the security center server 2 analyzes the event-related datum and identifies the attack type. Also, the security center server 2 generates the updated security policy 30 according to the analyzed result (S76) and stores the updated security policy 30 to the knowledge base 3 (S78) to upgrade the existing local security policy 400 to the updated security policy 30. Afterward, the security center server 2 deploys the attacked host 4 according to the updated security policy 30 (S80). Accordingly, the local security policy 400 in the host 4 is updated to generate a new local security policy 400 so that the host 4 cannot be attacked by the same attack type which had occurred and the host 4 can restore to the stable operation. Finally, the host 4 continually provides the self-monitoring operation through the detecting procedure 40 after the step S80.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A cloud system with an attack protection mechanism, comprising:
a host configured to install a detecting procedure to detect various data of the host and trigger an event when any one of the data exceeding corresponding threshold value;
a monitoring server connected to the host and configured to judge whether the host is attacked according to the event, and configured to send a warning message when the host is really attacked; and
a security center server connected to the monitoring server and the host and configured to receive the warning message;
wherein the security center server is configured to analyze the warning message to generate an updated security policy, and redeploy the host according to the updated security policy.

2. The cloud system in claim 1, wherein the host is configured to execute a local security policy therein, and the local security policy is configured to perform a security protection to the host and set the threshold values; the local security policy is configured to deploy the host and update the local security policy according to the updated security policy.

3. The cloud system in claim 2, wherein the local security policy and the updated security policy are a firewall policy, respectively.

4. The cloud system in claim 1, wherein the host is a physical machine (PM), a virtual machine (VM), a network switch, or a virtual switch.

5. The cloud system in claim 1, further comprising:
a knowledge base connected to the security center server and configured to store the updated security policy generated from the security center server.

6. The cloud system in claim 5, wherein the host, the monitoring server, the security center server, and the knowledge base are installed in an identical cabinet of a cloud-based data center.

7. The cloud system in claim 1, wherein the host is configured to simultaneously reply an event-related datum to the monitoring server when triggering the event; the monitoring server is configured to execute a notice policy therein and analyze the event-related datum to judge whether the host is attacked according to the notice policy; the monitoring server is configured to generate the warning message to notify the security center server according to the event-related datum when the host is really attacked.

8. The cloud system in claim 7, wherein the security center server is configured to execute an attack analysis algorithm therein; the security center server is configured to analyze the event-related datum and identify an attacked type to generate the updated security policy according to the attack analysis algorithm.

9. A protection method using for a cloud system with an attack protection mechanism, the cloud system having a host, a monitoring server connected to the host, and a security center server connected to the host and the monitoring server, the protection method comprising following steps:
(a) detecting various data of the host through a detecting procedure by the host;
(b) triggering an event when any one of the data exceeding corresponding threshold value;
(c) judging whether the host is attacked according to the event by the monitoring server;
(d) generating a warning message and notifying the security center server by the monitoring server when the host is really attacked;
(e) analyzing an attacked type to the host by the security center server according to the warning message sent from the monitoring server and then generating an updated security policy; and
(f) redeploying the host by the security center server according to the updated security policy.

10. The protection method in claim 9, further comprising following step:
(g) redeploying non-attacked hosts by the security center server according to the updated security policy.

11. The protection method in claim 9, wherein the step (c) comprises following steps:
(c1) receiving an event-related datum by the monitoring server, wherein the event-related datum is generated and replied by the host according to the event; and
(c2) analyzing the event-related datum according to a notice policy by the monitoring server to judge whether the host is attacked;
wherein in the step (d), the monitoring server is configured to generate the warning message to notify to the security center server according to the event-related datum.

12. The protection method in claim 11, wherein the step (e) comprises following steps:
(e1) receiving the event-related datum by the security center server;
(e2) analyzing the event-related datum according to an attack analysis algorithm to identify an attacked type to the host;
(e3) generating the updated security policy according to analyzed results.

13. The protection method in claim 9, further comprising following steps before the step (a):
(a01) booting the host;
(a02) deploying the detecting procedure for the host by the monitoring server;
(a03) deploying a local security policy for the host by the monitoring server; and
(a04) executing the local security policy by the host to perform a security protection and set the threshold values.

14. The protection method in claim 13, further comprising following steps before the step (a):
(a05) querying the security center server by the host according to the local security policy;
(a06) inquiring whether the updated security policy is generated by the security center server; and
(a07) redeploying the host by the security center server to update the local security policy according to the updated security policy when the updated security policy is generated.

15. The protection method in claim 14, wherein the cloud system further comprises a knowledge base connected to the security center server to store the updated security policy; in the step (a06), the security center server is configured to inquire whether the updated security policy is generated in the knowledge base.

16. The protection method in claim 13, wherein the local security policy and the updated security policy are a firewall policy, respectively.

17. A cloud system with an attack protection mechanism, comprising:
a host configured to install a detecting procedure to detect various data of the host and execute a local security policy therein, the local security policy is configured to perform security protection to the host and set threshold values of the data; the host is configured to trigger an event when any one of the data exceeding corresponding threshold value;
a monitoring server connected to the host and configured to judge whether the host is attacked according to the event, and configured to send a warning message when the host is really attacked; and
a security center server connected to the monitoring server and the host and configured to receive the warning message; and configured to analyze the warning message to identify an attacked type to the host and generate an updated security policy; and
a knowledge base connected to the security center server and configured to store the updated security policy generated from the security center server;
wherein the security center server is configured to redeploy the host and update the local security policy according to the updated security policy.

18. The cloud system in claim 17, wherein the host is configured to simultaneously reply an event-related datum to the monitoring server when triggering the event; the monitoring server is configured to execute a notice policy therein and analyze the event-related datum to judge whether the host is attacked according to the notice policy; the monitoring server is configured to generate the warning message to notify the security center server according to the event-related datum when the host is really attacked.

19. The cloud system in claim 18, wherein the security center server is configured to execute an attack analysis algorithm therein; the security center server is configured to analyze the event-related datum and identify an attacked type to generate the updated security policy according to the attack analysis algorithm.

20. The cloud system in claim 17, wherein the knowledge base is installed in the security center server.
